(19) United States
(12) Patent Application Publication
(10) Pub. No.: US 2021/0027228 A1
(43) Pub. Date: Jan. 28, 2021

(54) SHIPPING OPERATION ASSISTING SYSTEM, METHOD THEREFOR, AND STORAGE MEDIUM

(71) Applicant: Hitachi, Ltd., Tokyo (JP)

(72) Inventors: Atsushi Tomoda, Tokyo (JP); Hiroyuki Namba, Tokyo (JP); Hiromitsu Nakagawa, Tokyo (JP); Takeshi Uehara, Tokyo (JP)

(73) Assignee: Hitachi, Ltd., Tokyo (JP)

(21) Appl. No.: 16/811,579

(22) Filed: Mar. 6, 2020

(30) Foreign Application Priority Data
Jul. 24, 2019 (JP) 2019-136497

(51) Int. Cl. G06Q 10/06; G06N 5/04; G06N 20/00; G06Q 10/08; G06Q 10/10; G06Q 10/04

(52) U.S. Cl. CPC G06Q 10/06316; G06N 5/04; G06N 20/00; G06Q 10/04; G06Q 10/0875; G06Q 10/1091; G06Q 10/083

(57) ABSTRACT

A shipping operation assisting system generates feature amount data representing a relationship between a feature amount of a shipping operation and a working hour on the basis of operation record data representing a record of a plurality of shipping operations each of which is constituted by one or more of picking operations. The system refers to the feature amount data and generates a prediction model for predicting a working hour of a shipping operation corresponding to the operation instruction from the feature amount of the operation instruction on the basis of the generated feature amount corresponding to a sample point and the working hour corresponding to the feature amount. The system generates a sample point based on a distance with respect to an insufficient area where sample points in a feature amount space are insufficient when the prediction model is generated.

### CROSS-REFERENCE TO PRIOR APPLICATION

This application relates to and claims the benefit of priority from Japanese Patent Application number 2019-136497, filed on Jul. 24, 2019 the entire disclosure of which is incorporated herein by reference.

### BACKGROUND

The present invention generally relates to a shipping operation assisting system for assisting a shipping operation of an item in an item keeping location (for example, a warehouse or a factory), a method therefor, and a storage medium storing a computer program.

In recent years, order reception and shipment in accordance with the order reception are dealt with by order picking, for example, in a distribution warehouse. The order picking refers to a picking operation performed for each received order.

In general, the distribution warehouse is established between manufacturing bases and retailers or consumers. The distribution warehouse receives products from a plurality of manufacturing bases and keeps items until the items are appropriately shipped. In a case where users of the distribution warehouse are a plurality of retailers, mail-order companies, or the like, necessary items are selected and shipped for separate points of destinations to a plurality of consumers.

In conformity to the above-mentioned purpose, a distribution management system may be installed in the distribution warehouse in some cases. The distribution management system performs not only instruction of actual shipping operations but also processing such as order placement in accordance with demands for items in the order pickings based on order contents from retailers or consumers.

With regard to an environment surrounding the distribution warehouse, there is an increased demand for shortening a delivery period from the order reception until delivery of the order as target items become diversified in small quantities. For this reason, the promotion of efficiency of warehouse business is desired in the distribution warehouse, using limited work force and limited warehouse areas.

In response, for example, a prediction model of a working hour based on past business record data is created. By using the prediction model, optimization is performed by calculating the working hour in a case where the shipping operation or the like is changed.

In the optimization based on this prediction model, the prediction with a high accuracy to some extent can be performed regarding an area with much experience in the past. However, it is difficult to perform the high accurate prediction regarding an area with little experience in the past. With regard to the shipping operation, the past record data may be unevenly distributed in a limited particular area (for example, an area having a feature amount of the shipping operation), but there is also a possibility that a more efficient shipping operation may be available in the area with little experience in the past.

With regard to the above-mentioned prediction in the area with little experience in the past, PTL1 proposes a method of complementing a predicted value from plural pieces of past data existing in the vicinity of a point where the prediction is desired to be performed.

PTL1: Japanese Patent Laid-Open No. 2017-204107

### SUMMARY

However, unlike a case where a phenomenon continuously changes along with change in a feature amount as in a physical phenomenon, with regard to a shipping operation, in particular, in a case where the shipping operation is performed by a person, a situation may occur where a working hour abruptly changes once the feature amount such as a moving distance or a weight exceeds a certain value.

In the above-mentioned environment where the discontinuous and also abrupt change may occur, with regard to an area with little experience in the past, a sufficient prediction accuracy is not obtained from past data in the vicinity of the area. As a method of addressing this issue, a method is conceivable in which a user arbitrarily sets a feature amount belonging to the area with little experience in the past, and a dummy shipping operation based on the set feature amount is executed to measure a working hour. However, according to the above-mentioned method, there is a fear that operation efficiency in a distribution warehouse may be decreased.

The present invention has been made in view of the above-mentioned issue, and is aimed at making it possible to increase a prediction accuracy of a working hour with regard to an area with little experience in a past without executing a dummy shipping operation in accordance with an arbitrary setting of a feature amount by a user.

The present invention that addresses the above-described issue includes a feature amount calculation unit configured to generate feature amount data representing a relationship between a feature amount of a shipping operation and a working hour on the basis of operation record data representing a record of a plurality of shipping operations respectively corresponding to a plurality of operation instructions, a prediction model generation unit configured to generate a prediction model for predicting a working hour of a shipping operation corresponding to the operation instruction from the feature amount of the operation instruction on the basis of the feature amount data, and a sample point generation unit configured to generate, with respect to an insufficient area corresponding to an area where sample points in a feature amount space are insufficient when the prediction model is generated, a sample point based on a distance between the insufficient area and a sample point satisfying a predetermined condition among existing sample points, in which each of the operation instructions is an instruction for a shipping operation constituted by one or more of picking operations, and the prediction model generation unit generates the prediction model on the basis of the feature amount corresponding to the generated sample point and the working hour corresponding to the feature amount.

In accordance with the present invention, the prediction accuracy for the working hour with regard to the area with little experience in the past can be increased without executing the dummy shipping operation by setting the arbitrary feature amount.

### BRIEF DESCRIPTION OF THE DRAWINGS

FIG. 1 is a block diagram illustrating an outline of a shipping operation assisting system according to an embodiment of the present invention;

FIG. 2 is a block diagram illustrating a function of the shipping operation assisting system;

FIG. 3A is a plan view illustrating a physical arrangement example of a distribution warehouse;

FIG. 3B is a three-dimensional perspective view illustrating a physical arrangement example of a distribution warehouse;

FIG. 4 is a diagram illustrating a configuration example of operation instruction sheet data;

FIG. 5 is a diagram illustrating a configuration example of operation record data;

FIG. 6 is a diagram illustrating a configuration example of feature amount data;

FIG. 7 is a diagram illustrating a configuration example of an insufficient area list;

FIG. 8 is a diagram illustrating a configuration example of a search method list;

FIG. 9A is a diagram illustrating an example of operation instruction sheet before division;

FIG. 9B is a diagram illustrating an example of operation instruction sheet after division;

FIG. 10 is a diagram illustrating an example of the feature amount data based on the operation instruction sheet after the division;

FIG. 11A is a diagram illustrating an example of the operation instruction sheet before combination;

FIG. 11B is a diagram illustrating an example of the operation instruction sheet after combination;

FIG. 12 is a diagram illustrating an example of the feature amount data based on the operation instruction sheet after the combination;

FIG. 13 is a flow chart illustrating a procedure of sample point generation;

FIG. 14 is a schematic diagram of learning of a prediction model;

FIG. 15 is a graphic representation illustrating an example of a relationship between a feature amount and a working hour;

FIG. 16 is a diagram illustrating a feature amount space of a moving distance and a pick count;

FIG. 17 is a flow chart illustrating a procedure of an example of operation instruction sheet change;

FIG. 18 is a diagram illustrating a division example of the operation instruction sheet; and

FIG. 19 is a diagram illustrating a combination example of the operation instruction sheets.

### DESCRIPTION OF EMBODIMENTS

Hereinafter, embodiments of the present invention will be described with reference to the drawings.

First, an “operation instruction sheet”, a “shipping operation”, and a “picking operation” mentioned in the present embodiment are defined. The “operation instruction sheet” is an example of an operation instruction, and refers to a document such as a slip on which the operation instruction is described, for example. The “shipping operation” is an operation in accordance with one operation instruction sheet, and refers to an operation for transferring an item from an item keeping location (for example, a warehouse or a factory) to a predetermined location. The shipping operation is constituted by one or more of picking operations. It is noted that the present invention can also be applied to a shipping operation constituted by an operation other than the picking operation.

The “picking operation” refers to an operation for selecting an item along with the operation instruction sheet. Items to be selected may be diversified. For example, items such as books, compact discs (CDs), cloths, groceries, and food may be kept in the same location. Methods for the picking operation include, for example, a culling method and a seeding method. The “culling method” refers to a method for a worker to move to a location of an item and pick up the item. On the other hand, the “seeding method” refers to a method for a worker to pick up an item conveyed on a belt conveyor.

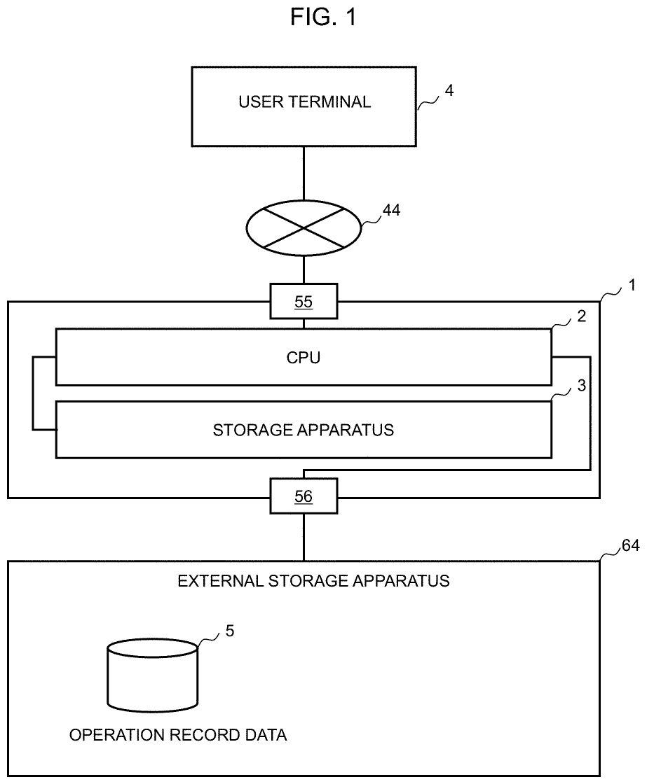

FIG. 1 is a block diagram illustrating an outline of a shipping operation assisting system. As illustrated in FIG. 1, a shipping operation assisting system 1 is constituted by a front-end interface device (FE-IF) 55, a back-end interface device (BE-IF) 56, a storage apparatus 3, and a central processing unit (CPU) 2 coupled to those. The FE-IF 55 is coupled to a user terminal 4 via a network 44.

The BE-IF 56 is coupled to an external storage apparatus 64. The storage apparatus 3 stores data and a program. When the CPU 2 executes the program, processing which will be described below is performed. The shipping operation assisting system 1 is a computer system including hardware (one or more of computers) as illustrated in FIG. 1. However, the above-mentioned configuration does not necessarily need to be used, and for example, a system that is realized when a program is executed on a computing resource pool (for example, a cloud platform) including computing resources of plural types may also be used.

It is noted that the FE-IF55 and the BE-IF 56 are examples of an interface apparatus. The interface apparatus may include one or more of communication interface devices. It is noted that the storage apparatus 3 may be at least a memory out of a memory and a permanent storage apparatus. The “memory” may be one or more of memory devices such as, for example, a volatile memory device. The “permanent storage apparatus” may be one or more of non-volatile storage devices (for example, a hard disk drive (HDD) or a solid state drive (SSD)).

The CPU 2 may be an example of a processor. The “processor” may be one or more of processor devices. At least one processor device may be a broad processor device such as a hardware circuit that performs a part or all of processing (for example, a field-programmable gate array (FPGA) or an application specific integrated circuit (ASIC)).

The external storage apparatus 64 is coupled to the shipping operation assisting system 1. The external storage apparatus 64 stores operation record data 5. It is noted that herein, an example is illustrated where the shipping operation assisting system 1 itself stores data to be used which is related to a distribution warehouse in the external storage apparatus 64. However, the shipping operation assisting system 1 itself does not necessarily need to manage the operation record data 5. For example, the operation record data 5 managed by the distribution management system may be obtained from a general distribution management system by the shipping operation assisting system 1 via the network 44. The external storage apparatus 64 may also be a part of the storage apparatus 3. In other words, the operation record data 5 may be stored in the storage apparatus 3 instead of, or in addition to, the external storage apparatus 64.

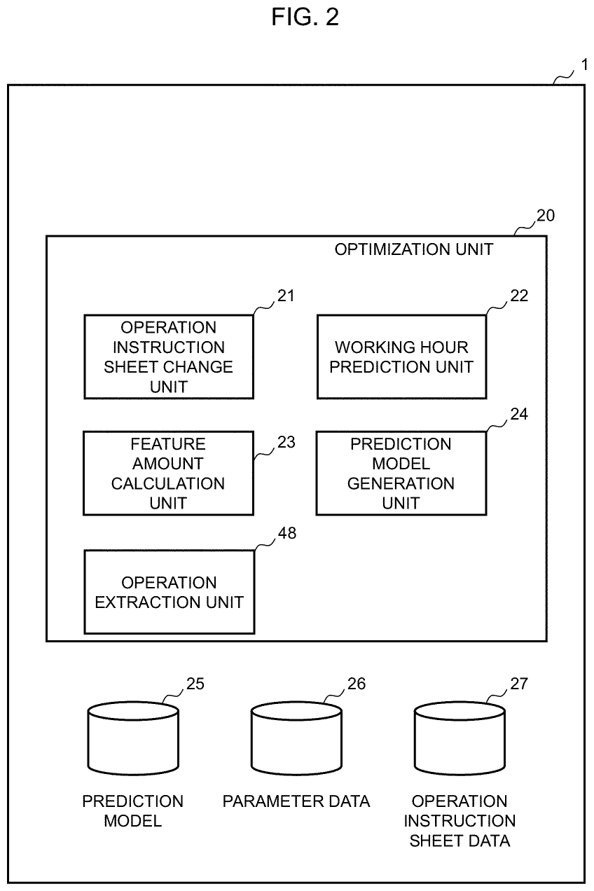

FIG. 2 is a block diagram illustrating a function of the shipping operation assisting system 1. As illustrated in FIG. 2, the shipping operation assisting system 1 includes an optimization unit 20 that performs optimization of the shipping operation. The shipping operation assisting system 1 stores a prediction model 25, parameter data 26, and operation instruction sheet data 27 in the storage apparatus 3, for example.

The prediction model 25 is a model for predicting a working hour. A model created using a related-art learning technique such as, for example, an autoregressive moving average model (for example, an autoregressive integrated moving average (ARIMA) model) or a neural network can be adopted as the prediction model 25. The parameter data 26 represents one or more of parameters used in the optimization of the shipping operation (for example, the learning of the prediction model 25). The operation instruction sheet data 27 is data representing one or more of the operation instruction sheets. The single operation instruction sheet is an instruction sheet of a single shipping operation and corresponds to a single order. With regard to the single shipping operation, for example, an item, a count, and a location are defined for each picking operation constituting the shipping operation.

The optimization unit 20 (FIG. 2) includes an operation instruction sheet change unit 21 that changes (for example, divides or combines) the operation instruction sheet, a feature amount calculation unit 23 that calculates a feature amount of the shipping operation or the picking operation, a prediction model generation unit 24 that generates the prediction model 25 for the working hour on the basis of the operation record data 5, a working hour prediction unit 22 that predicts a working hour to be spent for the shipping operation in accordance with the operation instruction sheet by using the prediction model 25 from the feature amount of the operation instruction sheet, and an operation extraction unit 48 that extracts data to be used for the learning of the prediction model 25 from the latest operation instruction sheet data and operation record data.

It is noted that in the explanation of the present embodiment, a function is described by using a term “XX unit” in some cases where XX may refer to any function, but the function may be realized when one or more of computer programs are executed by the CPU 2. The function may also be realized by one or more of hardware circuits (for example, an FPGA or an ASIC), or may also be realized by a combination of those. In a case where the function is realized when the program is executed by the CPU 2, since predetermined processing is performed by appropriately using the storage apparatus 3 and/or the interface apparatus and the like, the function may be at least a part of the CPU 2.

The processing described while the function is set as a subject may be processing performed by the CPU 2 or an apparatus including the CPU 2. The program may be installed from a program source. The program source may be, for example, a program distributed computer or a computer-readable recording medium (for example, a non-transitory recording medium). Descriptions of the respective functions are examples. A plurality of functions may be compiled into a single function, or a single function may be divided into a plurality of functions.

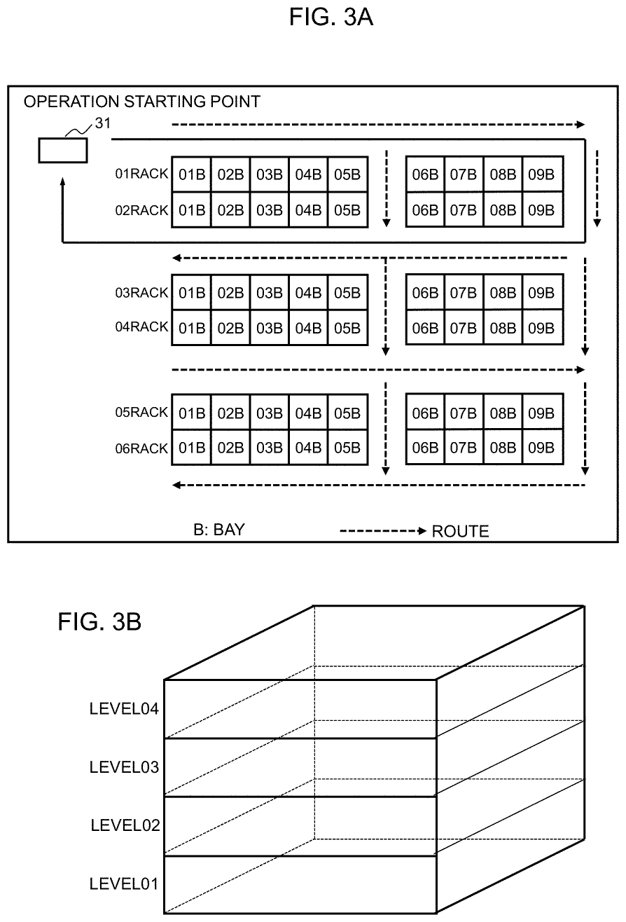

FIGS. 3A and 3B are drawings illustrating a physical arrangement example of the distribution warehouse to which the shipping operation assisting system 1 is applied. FIG. 3A is an arrangement diagram exemplifying “racks” and “bays” in a plan view of the warehouse. FIG. 3B is a three-dimensional perspective view of the warehouse, and is a three-dimensional arrangement diagram with a distinction of “levels” as a particular example of a physical arrangement in the warehouse. A plurality of shelves are disposed in the warehouse, and items can be stored and taken out from aisles that the respective shelves face. In FIGS. 3A and 3B, nine shelfs are arranged facing an aisle in the stated order of Bay 01, Bay 02, and up to Bay 09 in Rack 01.

Similarly, nine shelfs are also arranged in Rack 02, Rack 03, and Rack 04. Generally, an operation starting point 31 for the shipping operation is provided in the distribution warehouse, and picking is performed by sequentially following shelves that store items instructed to be shipped. An operation to deal with a single order, that is, a single order picking is effective, in principle, by being completed in a one-stroke route. The respective shelves are normally separated into a plurality of levels, and separated into four levels of Level 01 to Level 04 in the case of FIG. 3B.

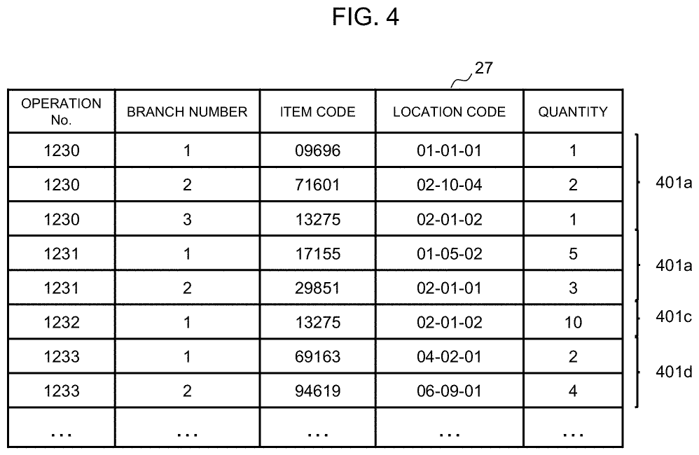

FIG. 4 illustrates a configuration example of the operation instruction sheet data 27. As illustrated in FIG. 4, the operation instruction sheet data 27 is constituted by an operation instruction sheet data set 401 for each order from a retailer, each consumer, or the like. In accordance with the example of FIG. 4, the operation instruction sheet data 27 includes four operation instruction sheet data sets 401a to 401d respectively corresponding to four operation instruction sheets. The operation instruction sheet data set 401 represents a single operation instruction sheet, that is, an operation instruction sheet of the shipping operation constituted by one or more of the picking operations. One row represents the picking operation. A single operation No. is allocated to the single shipping operation, and the same operation No. is recorded in rows corresponding to the picking operations belonging to the same shipping operation. The shipping operations are separated for each shipping destination or shipping destination group, and normally one worker performs the shipping operation.

As exemplified in FIG. 4, the operation instruction sheet data set 401a of an operation No. 1230 is constituted by three rows, which are respectively allocated with branch numbers 1, 2, and 3. Contents of the shipping operation represented by the operation instruction sheet data set 401a are as follows. First, the worker picks up one item having an item code 09696 of the branch number 1 from a location represented by a location code 01-01-01. Next, the worker moves to a location represented by a location code 02-10-04 of the branch number 2, and picks up two items having an item code 71601. Finally, the worker moves to a location represented by a location code 02-01-02 of the branch number 3, and picks up one item having an item code 13275.

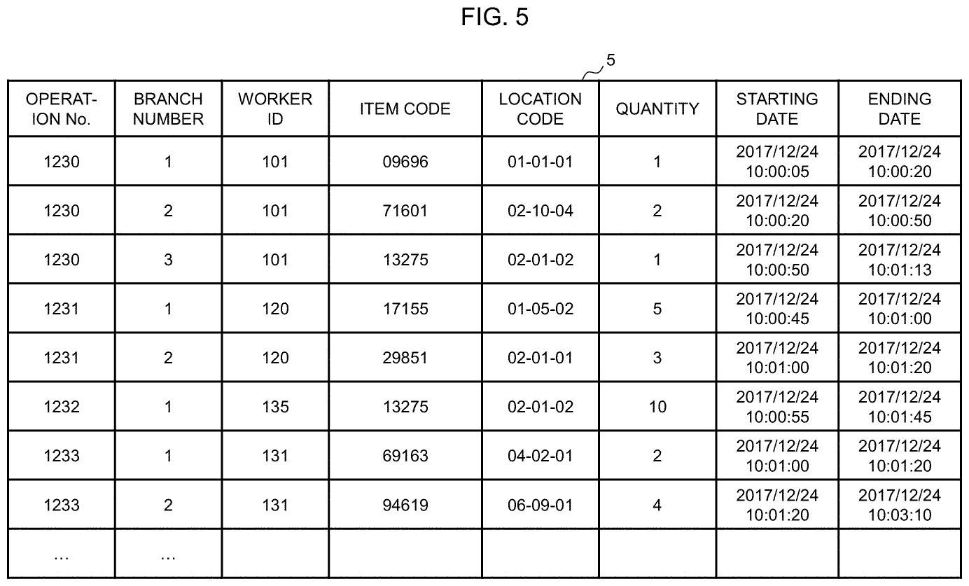

FIG. 5 illustrates a configuration example of the operation record data 5. The worker sequentially performs the shipping operations on the basis of the operation instruction sheet. The worker performs the picking operation using a handy terminal and the like, and recording using these devices each time an item is picked up. As a result, a time at which the picking operation has been performed is recorded in the operation record data 5. Therefore, for each of the actually preformed picking operations, the operation record data 5 turns into data to which a worker ID of the worker who has performed the picking operation, and a starting date and an ending data of the picking operation are input in addition to the same type of information (operation No., the branch number, the item code, the location code, and the quantity) included in the operation instruction sheet data set 401.

In the case of the operation record data 5 exemplified in FIG. 5, it is indicated that with regard to the branch number 1 of the operation No. 1230, the worker having a worker ID 101 has started an operation for picking up one item having an item code 09696 from a location represented by the location code 01-01-01 at 10:00:05 (5 seconds past 10 o'clock) on 2017/12/24 (Dec. 24, 2017) and ended at 10:00:20.

When the shipping operation is actually performed in the warehouse, a case may occur that the picking order is changed instead of the stated order of the branch numbers indicated in the operation instruction sheet data set 401, or a situation may occur that the picking is performed for a different quantity from a location indicated by a different location code. For this reason, the location code and quantity in the operation record data 5 may be the actual location code and quantity, or the location code and quantity may also be recorded as the record in addition to the location code and quantity indicated by the operation instruction sheet data set 401.

The feature amount calculation unit 23 generates feature amount data on the basis of the operation record data 5.

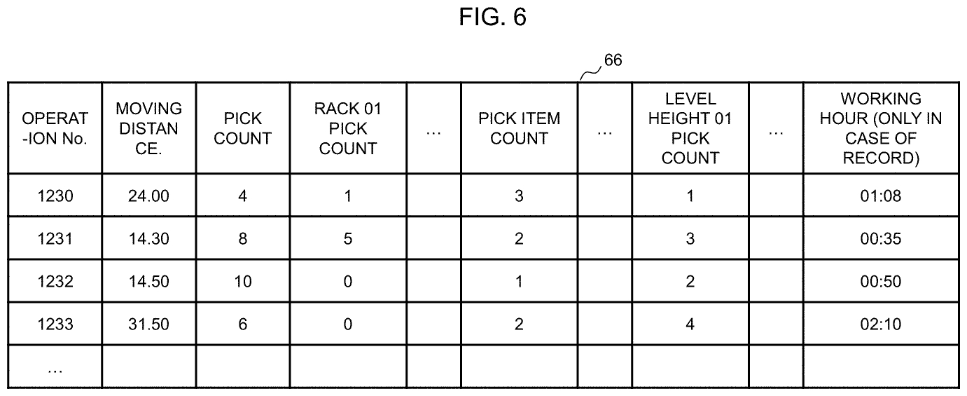

FIG. 6 illustrates a configuration example of the feature amount data. In accordance with the example of FIG. 6, a theoretical value of a moving distance is calculated from a predetermined traffic line or the like in the warehouse for each operation instruction sheet, and the theoretical value is recorded in feature amount data 66 as the moving distance. For each operation instruction sheet, a pick count (total number of pickup operations performed in the shipping operation) and its breakdowns (for example, the pick counts from the respective racks, the pick item counts, the pick counts from the respective levels, and the like) are also calculated and recorded in the feature amount data 66.

The moving distance, the pick count, the pick counts from the respective racks, and the like are examples of the feature amount. It is noted that the rack and the level can be specified, for example, from the location code. This is because the location code including values representing the rack and the level. In addition, according to FIG. 6, various feature amounts are aggregated for each operation instruction sheet. When the various feature amounts represented by the operation instruction sheet are calculated for each picking operation, the various feature amounts can be aggregated for each operation instruction sheet.

In this manner, with regard to each operation No., a pair of the feature amount calculated from the operation instruction sheet and the working hour obtained from the operation record data 5 can be generated. Therefore, when a general regression algorithm or the like is used on the basis of the feature amount data 66 exemplified in FIG. 6 in accordance with the operation record data 5, a prediction model for predicting the working hour can be generated.

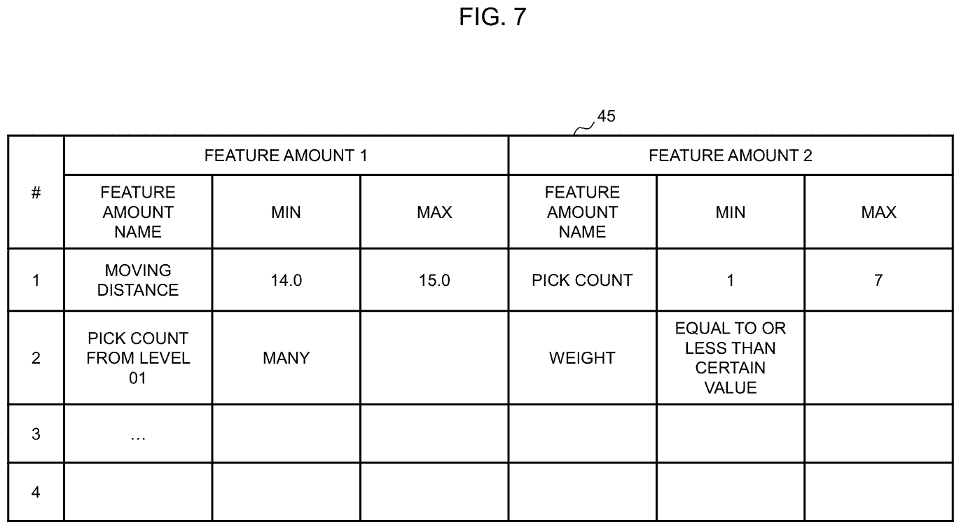

FIG. 7 illustrates a configuration example of an insufficient area list. A large number of sample points are generated in a feature amount space when the operation record data 5 is used. At this time, when ranges of values of the respective feature amounts are divided, depending on a combination of divided areas of the feature amounts, an area where the number of samples is significantly low exists. According to the present embodiment, the area where the number of samples is significantly low but the working hour is short (satisfactory) in the feature amount space is referred to as an “insufficient area”. It is noted that the “area where the number of samples is significantly low” may be an area where a ratio of the number of sample points belonging to the area to the total number of sample points is lower than a predetermined value.

In the list exemplified in FIG. 7, the moving distance “14.0 to 15.0 m” and the pick count “1 to 7 times” are cited as examples of the insufficient area. In this manner, each of the insufficient areas is defined by ranges of two feature amounts (hereinafter, feature amounts X and Y). With regard to the feature amounts of the respective types, in the prediction model 25 representing a relationship between the feature amount and the working hour, the range of the feature amount where, although the working hour is predicted to be short, the number of samples is significantly low (hereinafter, an insufficient range) may exist. A prediction accuracy for the working hour with regard to the insufficient range is not necessarily high.

Therefore, when optimization using this prediction model 25 is to be performed, the optimization is not performed in some cases. In view of the above, the insufficient areas where the number of samples is low and the predicted value is low (satisfactory) are previously listed in this manner. When the feature amounts of the two types which define the feature amount space to which the insufficient area belongs are set as the feature amounts X and Y, the respective insufficient areas may be areas defined by the insufficient range of the feature amount X and the insufficient range of the feature amount Y.

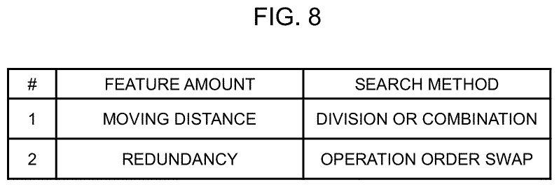

FIG. 8 illustrates a configuration example of a search method list. This list represents a relationship between a feature amount type and a search method. With regard to this list, in more detail, feature amounts (for example, a moving distance and a redundancy degree) are associated with a method (herein, a method for changing the operation instruction sheet) of searching for a feature amount pair (pair of a value of the feature amount X and a value of the feature amount Y) belonging to the insufficient area.

The search (change) method includes, for example, “division”, “combination” or “operation order swap”. In the “division”, the single operation instruction sheet is divided into two or more new operation instruction sheets. In the “combination”, at least a part of the instructions of the picking operation of at least one operation instruction sheet is combined with at least another one operation instruction sheet (for example, two or more operation instruction sheets are combined into a single operation instruction sheet). In the “operation order swap”, the operation order (order of the picking operations) represented by the operation instruction sheet is changed.

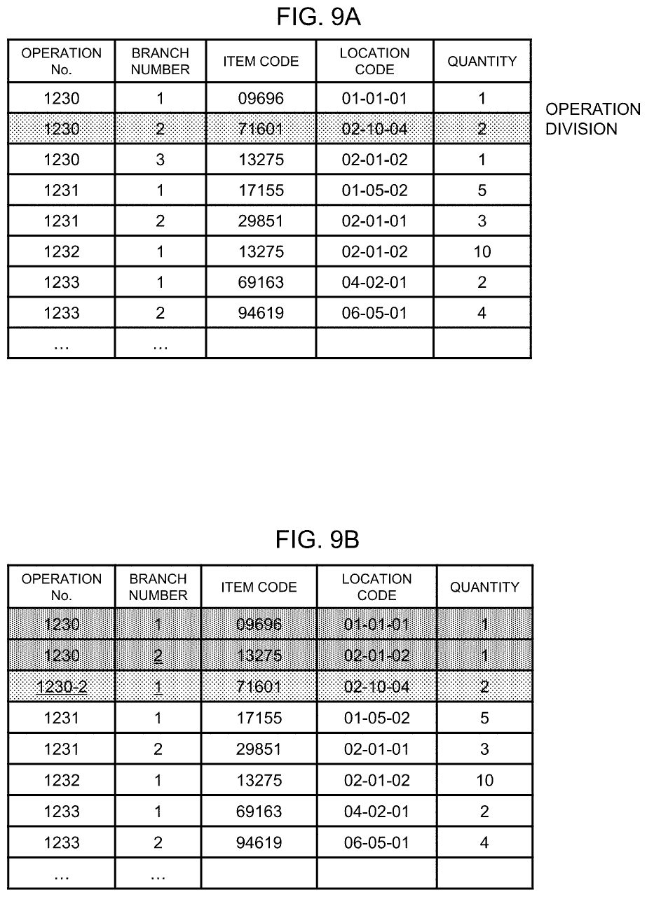

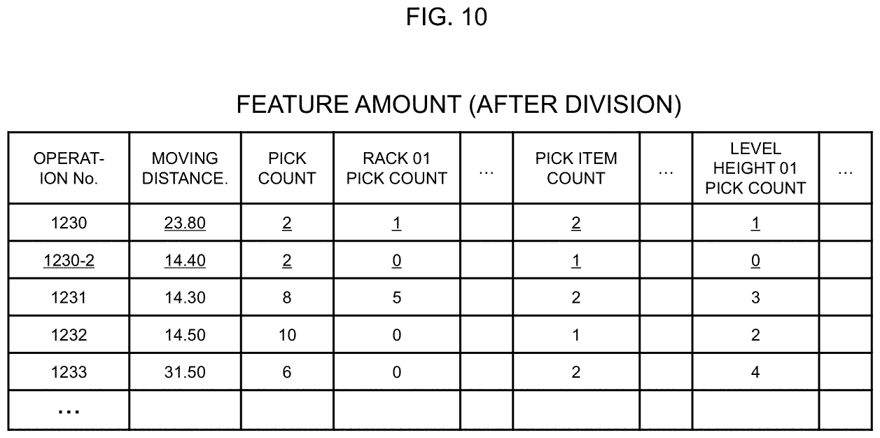

An example of division of the operation instruction sheet will be described with reference to FIGS. 9A and 9B and FIG. 10. FIGS. 9A and 9B illustrate examples of the operation instruction sheets before and after the division. According to FIG. 9A, the operation No. 1230 is the operation instruction sheet of the shipping operation for performing the three picking operations in the stated order of the branch numbers 1 to 3. The instruction of the picking operation of the branch number 2 in the operation instruction sheet is divided from the operation instruction sheet of the operation No. 1230 to be set as a single independent operation instruction sheet. That is, as illustrated in FIG. 9B, the picking operation of the branch number 2 before the division is set as the shipping operation corresponding to a new operation No. 1230-2. With this division, as illustrated in FIG. 10, the feature amounts of the operation No. 1230 change, and also, a row corresponding to the operation No. 1230-2 is added to the feature amount data.

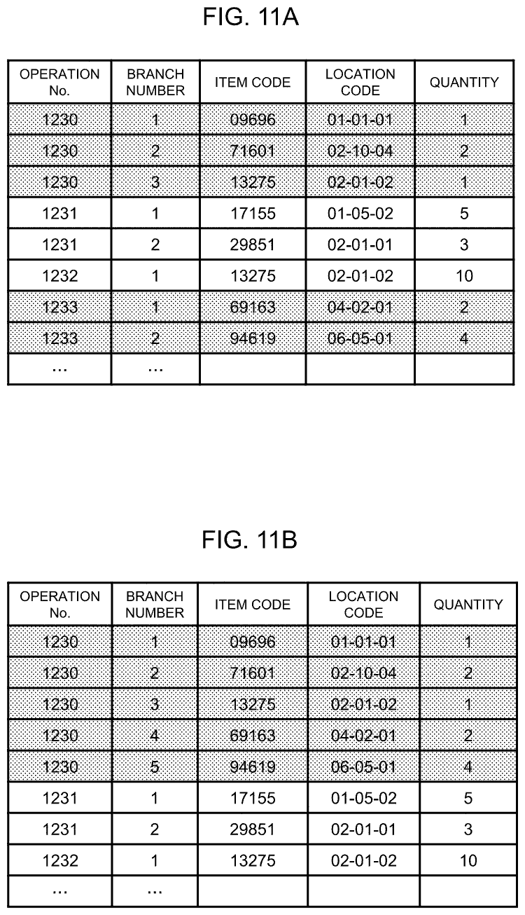

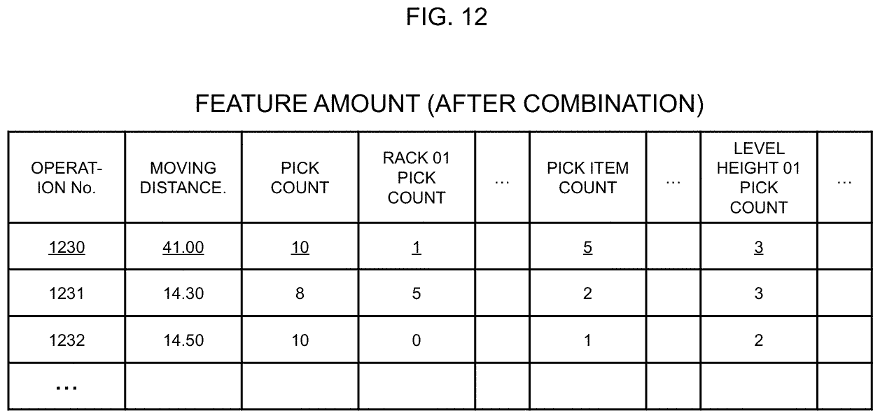

An example of combination of the operation instruction sheets will be described with reference to FIGS. 11A and 11B and FIG. 12. FIGS. 11A and 11B illustrate examples of the operation instruction sheets before and after the combination. In accordance with FIG. 11A, the operation instruction sheet of the operation No. 1230 and the operation instruction sheet of an operation No. 1233 exist. As illustrated in FIG. 11B, these operation instruction sheets are combined into a single operation instruction sheet. As a result, two picking operations belonging to the operation No. 1233 are added to the operation No. 1230, and as a result, the operation No. 1230 corresponds to the operation instruction sheet of the shipping operation constituted by five picking operations. With this combination, as illustrated in FIG. 12, the feature amounts of the operation No. 1230 change.

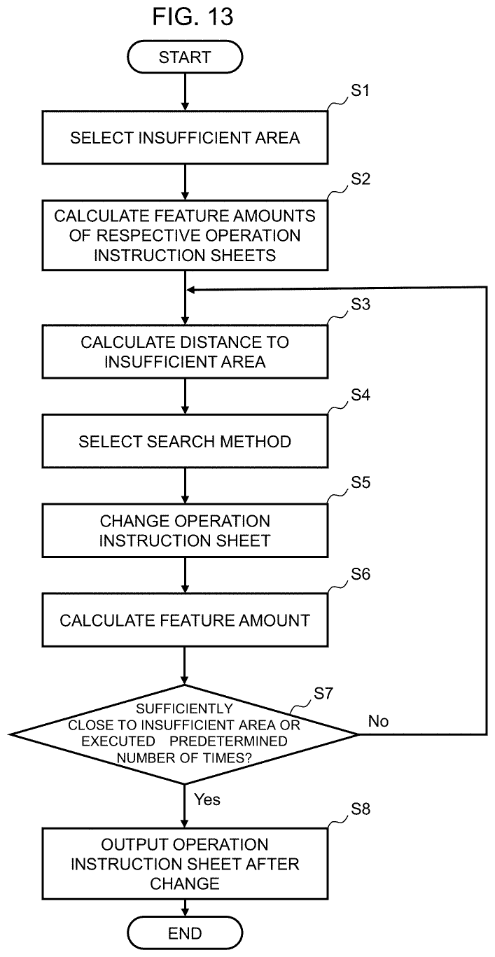

FIG. 13 is a flow chart illustrating a procedure of sample point generation. That is, FIG. 13 illustrates a procedure for generating the sample point in a desired area in the feature amount space. First, the feature amount calculation unit 23 selects a target insufficient area (for example, any insufficient area) from an insufficient area list 45 (S1). Next, the feature amount calculation unit 23 calculates a feature amount of each of the operation instruction sheets represented by the input operation instruction sheet data (S2).

Next, the operation instruction sheet change unit 21 calculates a distance between the insufficient area selected in step S1 and the feature amount of each of any one or more of the operation instruction sheets (S3). For example, with regard to one or more of the feature amounts indicated by the definition of the area of the feature amount space, the operation instruction sheet change unit 21 can calculates the distance using a Euclidean distance or the like. The operation instruction sheet change unit 21 compares the feature amount (for example, a center of the insufficient area) related to the insufficient area selected in step S1 with the feature amount (sample point) of each of any one or more of the operation instruction sheets described above.

The operation instruction sheet change unit 21 finds the most deviating feature amount by this comparison, and selects the search method corresponding to the type of the feature amount from the search method list illustrated in FIG. 8 (S4). For example, in accordance with FIG. 8, when the found feature amount is the moving distance, the search method to be selected is division or combination of the operation instruction sheet. It is noted that the relationship between the feature amount and the search method may be input from a user via a user interface, and the search method list indicating the relationship input from the user may be stored in the storage apparatus 3.

A user interface (for example, a graphical user interface (GUI)) may be provided to the user terminal 4 by a UI providing unit that is not illustrated in the drawing in the shipping operation assisting system 1, for example, and an input may be accepted from the user via the user interface. The operation instruction sheet change unit 21 changes the operation instruction sheet having the above-described most deviating feature amount by the search method selected in step S4 (S5).

The feature amount calculation unit 23 also calculates a feature amount of the operation instruction sheet after the change (S6). The feature amount calculation unit 23 determines whether or not a distance between the insufficient area selected in step S1 and the feature amount calculated in step S6 is sufficiently short (or, steps S3 to S7 are repeated the predetermined number of times) (S7). In a case where a determination result in step S7 is true (S7: Yes), the operation instruction sheet change unit 21 outputs the operation instruction sheet data representing the operation instruction sheet after the change (S8). On the other hand, in a case where the determination result in step S7 is false (S7: No), the process returns to step S3.

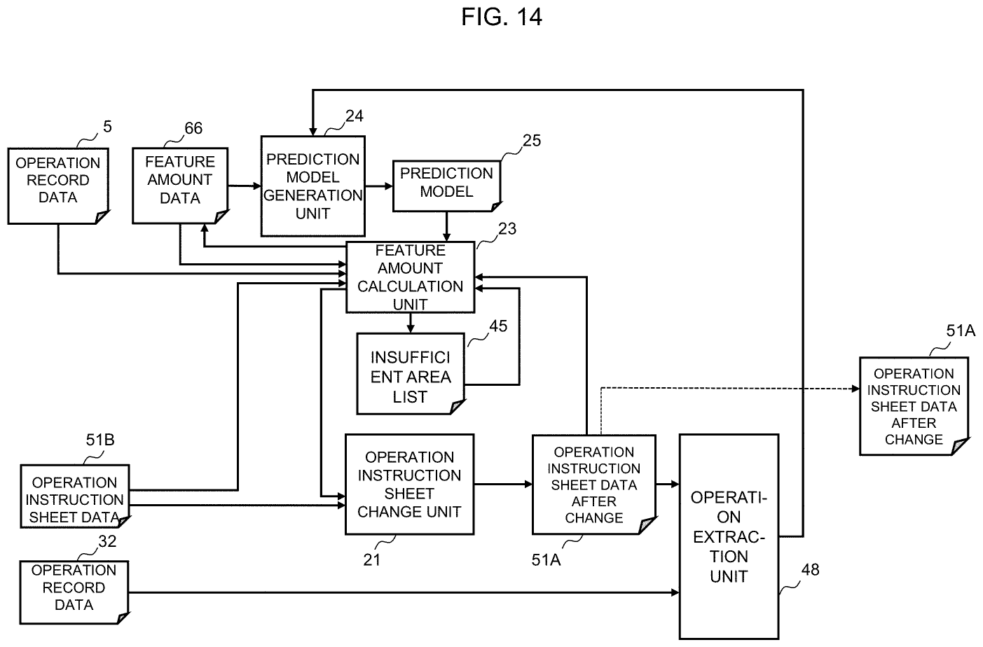

Next, the learning of the prediction model 25 will be described in more detail with reference to FIG. 14 to FIG. 19. FIG. 14 is a schematic diagram of the learning of the prediction model 25. The feature amount calculation unit 23 generates the feature amount data 66 on the basis of the operation record data 5 (data representing the past operation record). The prediction model generation unit 24 generates the prediction model 25 for predicting the working hour of the shipping operation corresponding to the operation instruction sheet from the feature amount of the operation instruction sheet on the basis of the relationship between the feature amount represented by the feature amount data 66 and the working hour. The feature amount calculation unit 23 outputs the insufficient area list 45 where the number of samples used for the generation of the prediction model 25 is insufficient in the feature amount space but the working hour is short on the basis of the prediction model 25 and the feature amount data 66.

In a case where operation instruction sheet data 51B is input from the user terminal 4, for example, the feature amount calculation unit 23 calculates various feature amounts of each of the operation instruction sheets represented by the operation instruction sheet data 51B. The feature amount calculation unit 23 selects the search method corresponding to the feature amount decided on the basis of the various calculated feature amounts and a distance to the target insufficient area represented in the insufficient area list 45. The operation instruction sheet change unit 21 changes one or more of the operation instruction sheets represented by the operation instruction sheet data 51B using the selected search method into one or more of the operation instruction sheets where the feature amount can be obtained at which the distance to the insufficient area is shortened.

Specifically, for example, the calculation of the feature amount of the operation instruction sheet, the calculation of the calculated feature amount and the distance to the insufficient area, the selection of the search method, and the operation instruction sheet change following the selected search method are repeated until the distance to the insufficient area becomes equal to or smaller than a predetermined value (or the number of repetitions reaches a predetermined number of times). The operation instruction sheet change unit 21 outputs operation instruction sheet data 51A representing the operation instruction sheet after the change to the user terminal 4, for example.

When the worker performs the shipping operation following the operation instruction sheet data 51A, operation record data 32 of the operation instruction sheet data 51A is obtained. The operation extraction unit 48 extracts and outputs the working hour represented by the operation record data 32 and the feature amount of the operation instruction sheet for each operation instruction sheet represented by the operation instruction sheet data 51A. The prediction model generation unit 24 performs the learning of the prediction model 25 on the basis of the working hour and the feature amount for each operation instruction sheet represented by the operation instruction sheet data 51A.

In addition, the shipping operation assisting system 1 may further include the operation extraction unit 48. The operation extraction unit 48 extracts the operation instruction in which the actual working hour is deviated by a predetermined period or longer with reference to a predicted time. That is, the operation extraction unit 48 extracts the operation instruction in a case where the working hour predicted by the prediction model 25 from the feature amount of the operation instruction is deviated with respect to the actual working hour in accordance with the operation instruction by the predetermined period or longer.

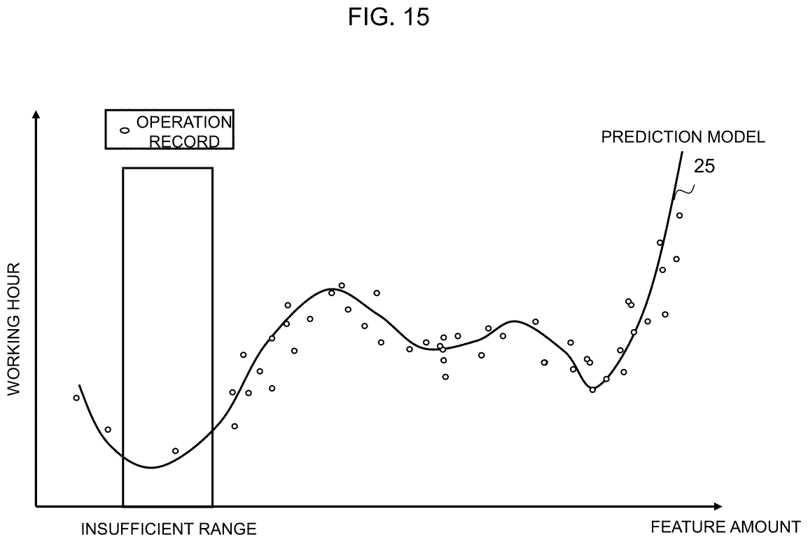

FIG. 15 illustrates an example of a graphic representation illustrating a relationship between the feature amount and the working hour. In accordance with the graphic representation in FIG. 15, a horizontal axis represents the feature amount such as the moving distance, the pick count, or a total weight, and a vertical axis represents the working hour. The prediction model 25 representing the relationship between the feature amount and the working hour is a model generated on the basis of a plurality of sample points (operation record) following the operation record data 5. The sample points do not necessarily evenly exist across the entire range of the feature amount. With regard to various feature amounts, the insufficient range where the short (satisfactory) working hour is obtained but the number of sample points is substantially low may occur in some cases.

The feature amount calculation unit 23 divides the feature amount space into small areas, and the predicted values and the numbers of sample points in the respective areas are aggregated. As a result of this aggregation, the feature amount calculation unit 23 adds the insufficient area where the working hour is short but the number of sample points is low to the list.

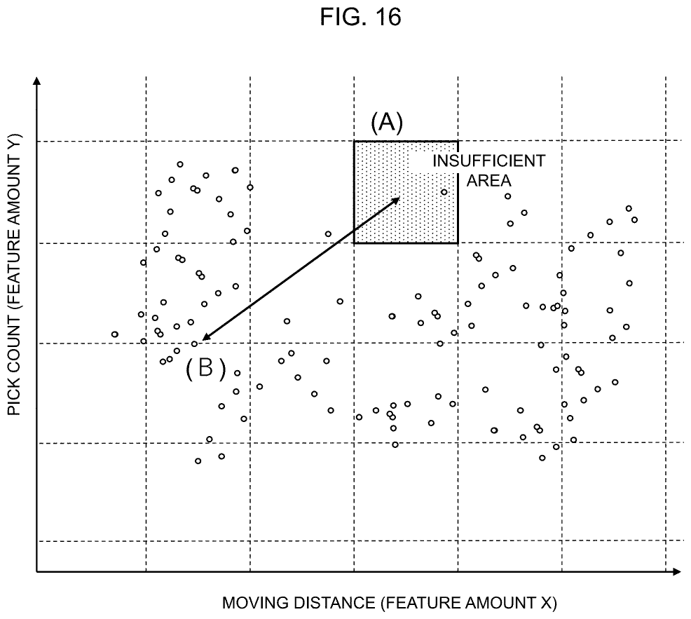

FIG. 16 illustrates the feature amount space of the moving distance and the pick count. This feature amount space is a feature amount space in which the moving distance is set as a first feature amount X, and the pick count is set as a second feature amount Y.

The operation instruction sheet change unit 21 changes the operation instruction sheet having the feature amount (B) sufficiently away from the extracted insufficient area (A) into an operation instruction sheet having a feature amount with the shortest distance to the insufficient area (A).

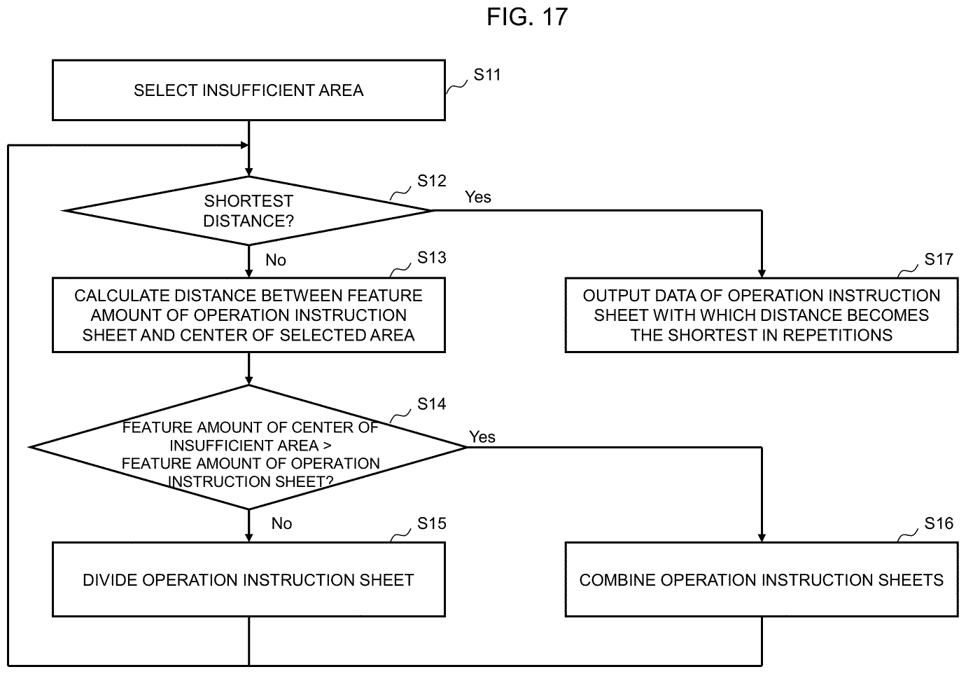

FIG. 17 is a flowchart illustrating a procedure of an example of the operation instruction sheet change. In FIG. 17, the search method is an example of division or change of the operation instruction sheet. The feature amount calculation unit 23 selects an insufficient area (S11). Next, the feature amount calculation unit 23 determines whether or not a distance between the feature amount of the operation instruction sheet and the insufficient area selected in step S11 is the shortest distance (S12).

The “distance to the insufficient area” mentioned herein may be, for example, a distance from the center of the insufficient area (example of a predetermined location). The “shortest distance” may be a predetermined distance (for example, zero, or, a distance equal to or shorter than the longest distance at which the distance from the center of the insufficient area falls within the insufficient area). In a case where a determination result in step S12 is false (step S12: No), the feature amount calculation unit 23 calculates a distance between the feature amount of the operation instruction sheet and a center of the selected insufficient area (S13).

Next, the operation instruction sheet change unit 21 determines whether or not the feature amount of the center of the selected area (for example, the moving distance) is larger than the feature amount of the operation instruction sheet (for example, the moving distance) (S14). In a case where a determination result in step S14 is false (step S14: No), the operation instruction sheet change unit 21 divides the operation instruction sheet having the feature amount into two or more sheets (S15).

On the other hand, in a case where the determination result in step S14 is true (step S14: Yes), the operation instruction sheet change unit 21 combines at least a part of the picking operations having a small feature amount in the operation instruction sheet with another operation instruction sheet (S17). Both S15 and S17 are processing for shortening the distance between the feature amount of the insufficient area and the feature amount of the operation instruction sheet.

In the repetitions in step S12 to step S16 by the number equal to or smaller than a predetermined number of times, in a case where the shortest distance is detected (step S12: Yes), the operation instruction sheet change unit 21 outputs the data representing the operation instruction sheet having the feature amount of the shortest distance (S17). It is noted that in a case where the shortest distance is not obtained even when step S12 to step S16 are repeated the predetermined number of times, data representing the operation instruction sheet having the feature amount corresponding to the shortest distance among the distances obtained in the repetitions may be output. Learning processing including the above-described change of the operation instruction sheet (learning processing of the prediction model 25) may continue repeatedly, for example, until the sufficient sample points are generated with respect to an undefined area.

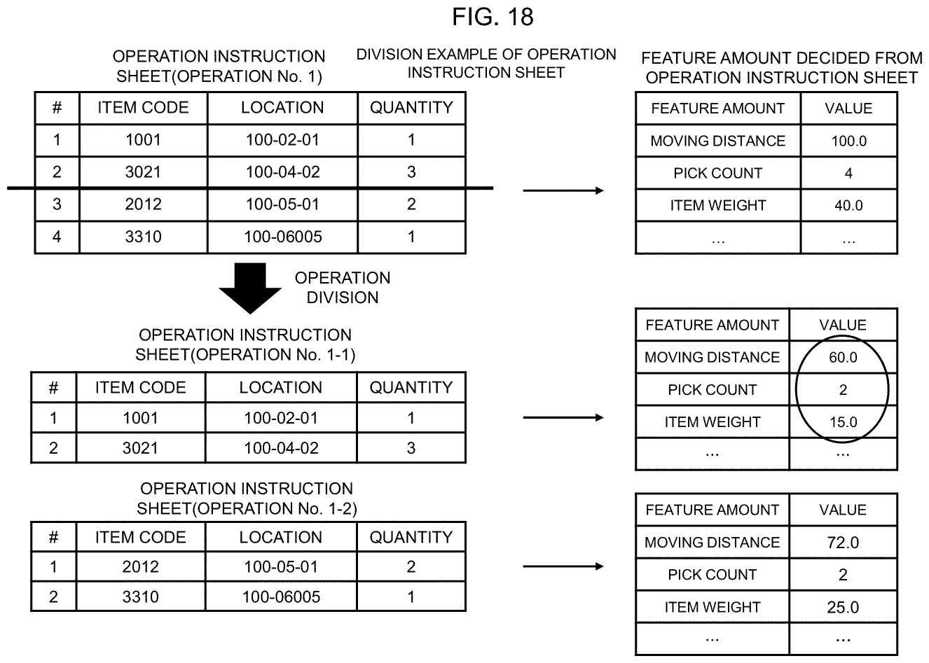

FIG. 18 illustrates an example of division of the operation instruction sheet. As illustrated in FIG. 18, an operation No. 1 is divided into an operation No. 1-1 and an operation No. 1-2. As a result, each of the feature amounts of the operation instruction sheets after the division becomes lower than the feature amount of the operation instruction sheet before the division.

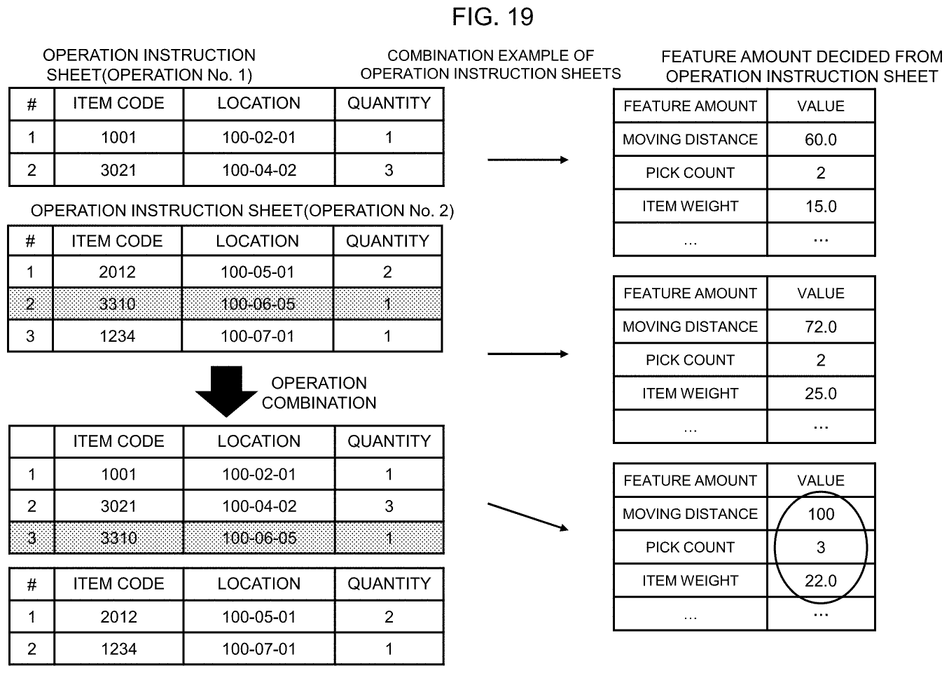

FIG. 19 illustrates an example of combination of the operation instruction sheets. As illustrated in FIG. 19, the entire operation No. 1 and a part of the operation No. 2 are combined with each other. As a result, the feature amount of the operation instruction sheet after the combination is higher than the feature amount of each of the operation instruction sheets before the combination.

The shipping operation assisting system 1 generates the sample point in the insufficient area by changing the operation instruction sheet in the above-described manner. There is a possibility that the working hour used for the entire operation following the operation instruction sheet data representing the operation instruction sheet after the change for generating the sample point in the insufficient area may be shorter than the working hour used for the entire operation following the operation instruction sheet data before the change. As a result, the shipping operation assisting system 1 can suggest further optimization of the shipping operation to the user.

The shipping operation assisting system 1 can also supply the operation instruction sheet after the change data for generating the sample point in the insufficient area and its operation record data (data representing the feature amount of the operation instruction sheet after the change and the working hour obtained by actually performing the operation) to the user, that is, supply new learning data of the prediction model 25 to the user in a situation with little experience. For this reason, the shipping operation assisting system 1 increases the accuracy of the prediction model 25, and as a result, correctness of the working hour predicted with regard to the operation instruction sheet is increased, so that the optimization of the shipping operation can be assisted.

Hereinafter, the shipping operation assisting system 1 can be summarized as follows.

[1] The shipping operation assisting system 1 includes the feature amount calculation unit 23, the prediction model generation unit 24, and a sample point generation unit (not illustrated). The feature amount calculation unit 23 generates the feature amount data representing the relationship between the feature amount of the shipping operation and the working hour on the basis of the operation record data 5 representing the record of the plurality of shipping operations respectively corresponding to the plurality of operation instructions.

The prediction model generation unit 24 generates the prediction model 25 on the basis of this feature amount data. This prediction model 25 predicts the working hour of the shipping operation corresponding to the operation instruction from the feature amount of the operation instruction. The shipping operation mentioned herein includes the picking operation with respect to the order as a typical example. Herein, descriptions will be provided while focusing on the picking operation. The feature amount in the above-described case is a management index of the picking operation, and is exemplified by the moving distance, the pick count, and the pick count in each rack in FIG. 6, and the like.

In addition, the feature amount space refers to a virtual space defined by a relationship between the working hour used for the picking operation and each of the various types of the feature amounts. It is noted however that since the number of coordinate axes is increased in accordance with the number of feature amounts to be dealt with, the feature amount space is not necessarily represented in a three-dimensional space, and is only indicated as information related to the virtualized definition. The prediction model 25 is a model formed by a method of plotting the sample points representing record values in the feature amount space.

At the time of the generation of the prediction model 25, the sample point generation unit generates a new sample point with respect to the insufficient area. As illustrated in FIG. 15, the insufficient area refers to the area where the existing sample points in the feature amount space are determined as insufficient in terms of whether or not the number of samples used in the generation of the prediction model 25 can be sufficiently secured. The sample point generation unit detects the distance from this insufficient area to the existing sample point. The sample point generation unit generates a new sample point on the basis of the detected distance.

It is noted that each of the operation instructions in the shipping operation assisting system 1 refers to the instruction for the shipping operation constituted by one or more of the picking operations. The prediction model generation unit 24 generates the prediction model 25 on the basis of the feature amount corresponding to the generated sample point and the working hour corresponding to the feature amount.

The optimization unit 20 will be mentioned to describe an advantage of the shipping operation assisting system 1. As illustrated in FIG. 2, the optimization unit 20 includes the operation instruction sheet 27, the feature amount calculation unit 23, an operation content generation unit 21, the prediction model 25, the working hour prediction unit 22, and the working hour prediction model generation unit (hereinafter, also simply referred to as a “prediction model generation unit”) 24. The operation instruction sheet 27 is data indicating operation instruction contents, and is a list indicating the item, the quantity, and the location for each operation. The feature amount calculation unit 23 calculates the feature amount with respect to the operation contents from the operation instruction sheet 27.

The operation content generation unit 21 generates a new picking operation equivalent to the sample point by dividing or combining one or a plurality of operations stipulated by the operation instruction sheet 27 or a part thereof. The prediction model 25 predicts the working hour from the feature amount calculated from the past operation record data. The working hour prediction unit 22 predicts the working hour using the prediction model 25 from the feature amount calculated from the operation instruction sheet 27. The prediction model generation unit 24 generates the prediction model 25 for predicting the working hour from the feature amount calculated from the past operation record data.

The feature amount specified by the sample point added as described above becomes the management index for deciding the moving distance, the pick count, the total weight, and the like with respect to the picking operation, for example. When the predicted value of the working hour used by the picking operation specified by this management index is within a desired range, since the operation efficiency is satisfactory, the optimization unit 20 determines that this may become a suggestion for improvement, and plans the picking operation equivalent to the added sample point. Thus, a probability is increased that the suggestion for improvement by an unconventional and novel idea can be performed.

That is, since the generated sample point is not a sample point arbitrarily set by the user but is the “sample point based on the distance between the insufficient area and the sample point satisfying the predetermined condition among the existing sample points”, decrease in the operation efficiency is avoided. It is noted that the sample point generation unit (not illustrated) may further include the operation instruction sheet change unit 21.

Up to now, a sufficient prediction accuracy is not obtained by performing complementation from the neighboring past data where the measure planning is similar. In contrast, the shipping operation assisting system 1 expands the area with the record, and actually experiments and confirms the picking operation equivalent to the sample point (operation) having the desired feature amount using contents based on the measure planning.

In accordance with the above-described experiment, since the working hour can be correctly measured, the prediction model 25 can be further sophisticated, and also the optimization can be realized. As a result, when the item arrangement is changed in an unexperienced area too, a satisfactory result can be obtained.

An area having a satisfactory record value where a large number of sample points exist is generally an arrangement of selling items in many cases. The shipping operation assisting system 1 can also perform an effective suggestion for improvement with respect to an item at a middle or lower rank without mutilating the arrangement of the well-selling items. The shipping operation assisting system 1 can perform the novel suggestion for improvement without negatively affecting the entirety.

[2] In the shipping operation assisting system 1 according to [1] described above, the sample point generation unit (not illustrated) may generate the sample point with respect to the insufficient area in the following manner. That is, the sample point generation unit performs the instruction change so as to change the operation instruction. This instruction change refers to the change into one or more operation instructions having a certain feature amount. The certain feature amount refers to one near the insufficient area. That is, the certain feature amount refers to a feature amount located at a distance equal to or shorter than a predetermined distance from a predetermined location of one or a plurality of the input insufficient areas.

As described above, the sample point generation unit detects the distance from this insufficient area to the existing sample point. The sample point generation unit generates the new sample point on the basis of the detected distance. Thus, since the newly generated sample point is the unexperienced area suggested by the insufficient area, the novel and practical suggestion for improvement can be performed within a range that is not excessively deviating from the existing feature amount.

[3] In the shipping operation assisting system 1 according to [2] described above, the instruction change may be any one of the instruction division and the instruction combination. The instruction division is the operation instruction for dividing the single operation instruction into two or more new instructions. The instruction combination is the operation instruction for combining a part of the instructions of the picking operations with another operation instruction. That is, the instruction combination is the operation instruction for combining an instruction of at least a part of the picking operations of at least one operation instruction with at least one another operation instruction.

The operation for dealing with one order is also referred to as single order picking. The operation for dealing with a plurality of orders is also referred to as multi-order picking. While these single and multiple operation changes are mixed, the possibility of the suggestion for improvement with respect to the picking operation can be increased by the assist of the shipping operation assisting system 1.

[4] In the shipping operation assisting system 1 according to [3] described above, the instruction change may select which one of the instruction division and the instruction combination using the following criterion for judgement. In a case where the feature amount in the predetermined location of the insufficient area is lower than the feature amount belonging to the sample point satisfying the predetermined condition, the instruction change is the instruction division. On the other hand, in a case where the feature amount in the predetermined location of the insufficient area is higher than the feature amount belonging to the sample point satisfying the predetermined condition, the instruction change is the instruction combination.
[5] In the shipping operation assisting system 1 according to [1] described above, the operation instruction may be changed in the following manner. First, the feature amount calculation unit 23 refers to the information representing the relationship between the feature amount type and the operation instruction changing method. Herein, as exemplified in FIG. 8, the operation instruction changing method is selected as the search method corresponding to the type of the feature amount belonging to the sample point satisfying the predetermined condition. Herein, the sample point generation unit (not illustrated) changes the one or more of the operation instructions by the selected operation instruction changing method.
[6] The shipping operation assisting system 1 according to [2] described above may further include the operation extraction unit 48. The operation extraction unit 48 extracts the operation instruction with which the actual working hour is deviated with respect to the predicted time by the predetermined period or longer. That is, the operation extraction unit 48 extracts the operation instruction in a case where the working hour of the prediction model 25 predicted from the feature amount of the operation instruction is deviated with respect to the actual working hour in accordance with the operation instruction by the predetermined period or longer.
[7] In the shipping operation assisting system 1 according to [6] described above, the operation extraction unit 48 may display the operation contents represented by the extracted operation instruction. The operation extraction unit 48 acts on the respective units illustrated in FIG. 14, and issues the operation instruction sheet after the change data as a slit, which reflects practice of the picking operation.
[8] In the shipping operation assisting system 1 according to [6] described above, the prediction model generation unit 24 may exclude the extracted feature amount of the operation instruction and the working hour from the learning data of the prediction model 25. That is, the prediction model generation unit 24 acts on the respective units illustrated in FIG. 14, and extracts the operation instruction with which the actual working hour is deviated with respect to the predicted time by the predetermined period or longer. The extracted feature amount of the operation instruction and the working hour are excluded from the learning data of the prediction model 25. Thus, the operation instruction that is likely to be inappropriate to the practice of the picking operation does not reflect on the practice, and the business is hardly disturbed.
[9] In the shipping operation assisting system 1 according to [6] described above, the prediction model generation unit 24 may correct the prediction model 25 on the basis of one or more of the parameters including the explanatory parameter for the deviation between the predicted working hour and the actual working hour. The parameter data 26 illustrated in FIG. 2 is the parameter used for the optimization of the shipping operation (for example, the learning of the prediction model 25), that is, the information obtained by generalizing business know-how to be accumulated to be usable.

However, the business know-how is a matter of common knowledge for a person skilled in the business, but is not generalized in many cases. In view of the above, in the shipping operation assisting system 1, in a case where the actual working hour is deviated with respect to the predicted working hour, the prediction model generation unit 24 also accumulates the information as the business know-how. That is, the prediction model 25 may be corrected by linking an explanatory note associated with the business know-how to the operation instruction that is likely to be inappropriate to the practice of the picking operation. As a result, it becomes easier for a nonexpert to receive the know-how of the skilled person.

What is claimed is:

1. A shipping operation assisting system comprising:
a feature amount calculation unit configured to generate feature amount data representing a relationship between a feature amount of a shipping operation and a working hour on the basis of operation record data representing a record of a plurality of shipping operations respectively corresponding to a plurality of operation instructions each of which is an instruction for a shipping operation constituted by one or more of picking operations;
a prediction model generation unit configured to refer to the feature amount data and generate a prediction model for predicting a working hour of a shipping operation corresponding to the operation instruction from the feature amount of the operation instruction on the basis of the generated feature amount corresponding to a sample point and the working hour corresponding to the feature amount; and
a sample point generation unit configured to generate, with respect to an insufficient area corresponding to an area where sample points in a feature amount space are insufficient when the prediction model is generated, a sample point based on a distance between the insufficient area and a sample point satisfying a predetermined condition among existing sample points.

2. The shipping operation assisting system according to claim 1, wherein
the sample point generation unit generates the sample point with respect to the insufficient area by performing instruction change for changing one or a plurality of input operation instructions into one or more operation instructions having a feature amount at which a distance from a predetermined location of the insufficient area becomes equal to or smaller than a predetermined distance.

3. The shipping operation assisting system according to claim 2, wherein
the instruction change is any one of instruction division for dividing one operation instruction into new two or more operation instructions, and instruction combination for combining an instruction of at least a part of the picking operations of at least one operation instruction with at least one another operation instruction.

4. The shipping operation assisting system according to claim 3, wherein:
the instruction change is the instruction division in a case where the feature amount in the predetermined location of the insufficient area is lower than a feature amount belonging to the sample point satisfying the predetermined condition; and
the instruction change is the instruction combination in a case where the feature amount in the predetermined location of the insufficient area is higher than the feature amount belonging to the sample point satisfying the predetermined condition.

5. The shipping operation assisting system according to claim 1, wherein:
the feature amount calculation unit refers to information representing a relationship between a feature amount type and an operation instruction changing method, and selects an operation instruction changing method corresponding to a type of the feature amount belonging to the sample point satisfying the predetermined condition; and
the sample point generation unit changes the one or more of the operation instructions by the selected operation instruction changing method.

6. The shipping operation assisting system according to claim 2, further comprising:
an operation extraction unit configured to extract the operation instruction with regard to each of one or more of the operation instructions after the instruction change in a case where the working hour predicted from the feature amount of the operation instruction using the prediction model is deviated with respect to the actual working hour in accordance with the operation instruction by a predetermined period or longer.

7. The shipping operation assisting system according to claim 6, wherein
the operation extraction unit displays operation contents represented by the extracted operation instruction.

8. The shipping operation assisting system according to claim 6, wherein
the prediction model generation unit excludes the feature amount of the extracted operation instruction and the working hour from learning data of the prediction model.

9. The shipping operation assisting system according to claim 6, wherein
the prediction model generation unit corrects the prediction model on the basis of one or more of parameters including an explanatory parameter of the deviation between the predicted working hour and the actual working hour.

10. A shipping operation assisting method comprising:
generating feature amount data representing a relationship between a feature amount of a shipping operation and a working hour on the basis of operation record data representing a record of a plurality of shipping operations respectively corresponding to a plurality of operation instructions each of which is an instruction for a shipping operation constituted by one or more of picking operations;
referring to the feature amount data and generating a prediction model for predicting a working hour of a shipping operation corresponding to the operation instruction from the feature amount of the operation instruction on the basis of the generated feature amount corresponding to a sample point and the working hour corresponding to the feature amount; and
generating, with respect to an insufficient area corresponding to an area where sample points in a feature amount space are insufficient when the prediction model is generated, a sample point based on a distance between the insufficient area and a sample point satisfying a predetermined condition among existing sample points.

11. A non-transitory computer-readable storage medium storing a program for causing a computer to execute:
generating feature amount data representing a relationship between a feature amount of a shipping operation and a working hour on the basis of operation record data representing a record of a plurality of shipping operations respectively corresponding to a plurality of operation instructions each of which is an instruction for a shipping operation constituted by one or more of picking operations;
referring to the feature amount data and generating a prediction model for predicting a working hour of a shipping operation corresponding to the operation instruction from the feature amount of the operation instruction on the basis of the generated feature amount corresponding to a sample point and the working hour corresponding to the feature amount; and
generating, with respect to an insufficient area corresponding to an area where sample points in a feature amount space are insufficient when the prediction model is generated, a sample point based on a distance between the insufficient area and a sample point satisfying a predetermined condition among existing sample points.
